(19) United States
(12) Patent Application Publication
(10) Pub. No.: US 2007/0035450 A1
(43) Pub. Date: Feb. 15, 2007

(54) Dual frequency antenna

(75) Inventors: The-Nan Chang, Taipei City (TW); Hsu-Hsien Sun, Taipei City (TW)

Correspondence Address: BACON & THOMAS, PLLC, 625 SLATERS LANE, FOURTH FLOOR, ALEXANDRIA, VA, 22314, US

(73) Assignee: Tatung University, Taipei City (TW)

(21) Appl. No.: 11/267,143

(22) Filed: Nov. 7, 2005

(30) Foreign Application Priority Data
Aug. 12, 2005 (TW) 094127437

(51) Int. Cl. H01Q 1/38

(52) U.S. Cl. 343/700 MS

(57) ABSTRACT

The present invention relates to a dual frequency antenna, which integrates a square ring antenna and a patch antenna in order to have a compact circuit area that receives both low and high frequencies, to be used as the antenna of wireless LAN, wherein the wireless LAN is one of the following: IEEE 802.11a, IEEE 802.11b, or IEEE 802.11g.

### BACKGROUND OF THE INVENTION

1. Field of the Invention

The present invention relates to a dual frequency antenna and, more particularly, to a dual frequency antenna that combines a square ring with a patch of the same surface.

2. Description of the Related Art

Wireless LAN device, such as a wireless network card and wireless LAN access point, can simplify the setting of network hardware framework and also supply enough bandwidth for data transmission. Currently, wireless LAN can be classified into three types: IEEE 802.11a, IEEE 802.11b, and IEEE 802.11g, and each has a respective working frequency of 2.4 GHz (2400˜2484 MHz), 5.2 GHz (5150˜5350 MHz), and 2.4 GHz, and respectively has a bandwidth of 11M, 54M, and 54M byte. Therefore, in order to provide the function of multiple data transmissions at the same time, a dual frequency antenna is required in a wireless LAN device to ensure that the wireless LAN can be switched between two working frequencies, 2.4 GHz and 5.2 GHz.

In addition, to reach the goal of miniaturizing a wireless LAN device, the preferred antenna for the wireless LAN device is a micro-strip antenna. However, currently there is no suitable micro-strip antenna to be used in a wireless LAN device. Therefore, it is desired to contrive a miniaturized dual frequency antenna to be used in a wireless LAN device in order to satisfy the demand of the consumers.

### SUMMARY OF THE INVENTION

The purpose of the present invention is to provide a dual frequency antenna, which has a compact circuit area that receives signals of dual frequencies.

To fulfill the purpose above, the present invention provides a dual frequency antenna that comprises: a square ring, which has a central space; a patch, which is placed in the central space of the square ring; a feed line for stimulating the square ring to create a square ring antenna, and stimulating the patch to create a patch antenna; wherein the square ring, the patch and the feed line are located on the same surface. The dual frequency antenna can be the antenna required for a wireless LAN device.

### BRIEF DESCRIPTION OF THE DRAWINGS

FIG. 1 is a schematic drawing of the first embodiment of a dual frequency antenna according to the present invention;

FIG. 2 is a waveform chart showing return loss of the first embodiment of a dual frequency antenna according to the present invention;

FIG. 3 is a schematic drawing of the second embodiment of a dual frequency antenna according to the present invention;

FIG. 4 is a schematic drawing of the third embodiment of a dual frequency antenna according to the present invention;

FIG. 5 is a cross-sectional view of the third embodiment of a dual frequency antenna according to the present invention;

FIG. 6 is a low frequency gain chart of the third embodiment of a dual frequency antenna according to the present invention; and

FIG. 7 is a high frequency gain chart of the third embodiment of a dual frequency antenna according to the present invention.

### DETAILED DESCRIPTION OF THE PREFERRED EMBODIMENT

Square ring antenna and patch antenna are two common antennas, but currently there is no prior art regarding the combined use of the two. Therefore, the present invention discloses a dual frequency antenna combining the square ring antenna and patch antenna in order to create an antenna with a compact circuit area which receives both high and low frequencies. Furthermore, one of the preferred embodiments below discloses a two-level substrate of the dual frequency antenna, which has optimum performance.

First embodiment:

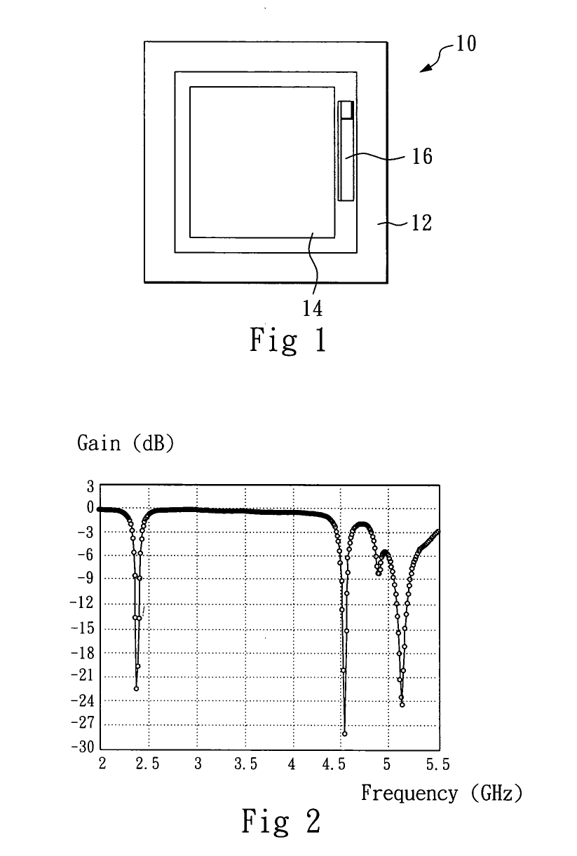

As shown in FIG. 1, the dual frequency antenna 10 of this embodiment comprises a square ring 12, a patch 14, and a feed line 16, wherein the square ring 12, the patch 14, and the feed line 16 do not connect electrically with each other. The square ring 12, the patch 14, and the feed line 16 are placed on the surface of the single-level substrate, and the preferred dielectric coefficient ε of the single-level substrate is 4.4. Through signal-coupling, the feed line 16 respectively stimulates the square ring 12 and the patch 14 in order to create a square ring antenna and a patch antenna; wherein the square ring antenna is responsible for receiving and transmitting low frequency signals (pre-determined value is 2.4 GHz), and the patch antenna is responsible for receiving and transmitting high frequency signals (pre-determined value is 5.2 GHz).

As known, the working frequency of an antenna is related to the physical measurements of the antenna itself. Therefore, the required circumference of the square ring antenna is one wavelength of the corresponding low frequency signal, so the length of each side of the square ring is much shorter than the required length of other common antennas which have one-half of the wavelength, and the square ring antenna, with characteristics of immobile directivity and occupying a particularly small area. Additionally, the square ring antenna can be manufactured by using printed circuit process, and by using the circuit board, which is made of FR4 material, a preferable electric property can be obtained. Furthermore, because the square ring antenna defines a central space, the user can adjust the width of square ring depending on the demanded impedance value. In general, if the width of the ring is narrow, the impedance of the square ring antenna is high. Because the pre-determined working frequency of the square ring antenna is 2.45 GHz, the preferred length of the inner side of the square ring 12 is 15.4 mm, and the preferred width of the ring is 2.3 mm. Moreover, the patch 14 can be placed in the central space of the square ring antenna 12 in order to minimize the circuit area.

Because the pre-determined working frequency of the patch antenna is 5.2 GHz, the preferred length of each side of the patch 14 is 13 mm. The length of the feed line 16 can be determined according to the demand of the user, wherein the preferred length is 9 mm and the preferred width is 1 mm. The distance between the feed line 16 and square ring 12 and patch 14 is respectively 0.2 mm.

As shown in FIG. 2, the dual frequency antenna 10 within the frequency ranges of 2.45 GHz, 4.6 GHz, and 5.2 GHz has low return loss, wherein the return loss for each frequency has respective gain of −23, −28, and −25, which is identical to the two frequencies of the wireless LAN device. Therefore, the dual frequency antenna 10 of the present invention can be the antenna used in a wireless LAN device.

Second embodiment:

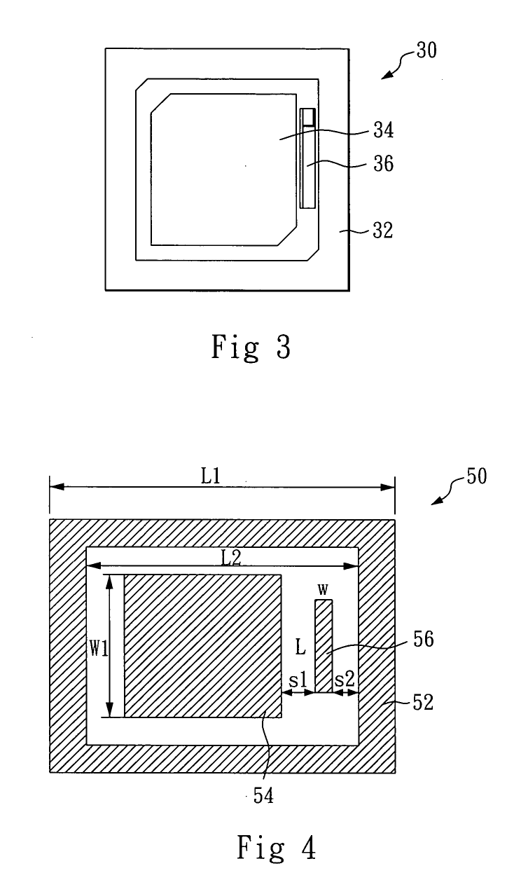

Because the dual frequency antenna 10 in the first embodiment has the characteristic of directivity, which is only suitable for use in receiving and transferring polarized signals with specific directions. To receive other signals such as circular polarized signals, the first embodiment has to be slightly modified. As shown in FIG. 3, the dual frequency antenna 30 of the present invention comprises a square ring 32, a patch 34, and a feed line 36, wherein the square ring 32, the patch 34, and the feed line 36 do not connect electrically with each other. The characteristics of the feed line 36 are the same as those of the feed line 16, and the characteristics of the square ring 32 are similar to those of the square ring 12; however, the square ring 32 is different from the first embodiment in that two inner opposed angles are not right angles but extended bevel edges, and the preferable length of such bevel edges is 1 mm. The characteristic of patch 34 is similar to the patch 14, but the patch 34 is different form the first embodiment in that two inner opposed angles are not right angles. By modifying the right angles, bevel edges are formed, and the length of the edges is preferably 2.3 mm. Because of the unique shapes of the square ring 32 and the patch 34, the dual frequency antenna of the embodiment 2 can receive and transfer both the low frequency signal (pre-determined value is 2.4 GHz) and high frequency signal (pre-determined value is 5.2 GHz) of the circular polarization.

Third embodiment:

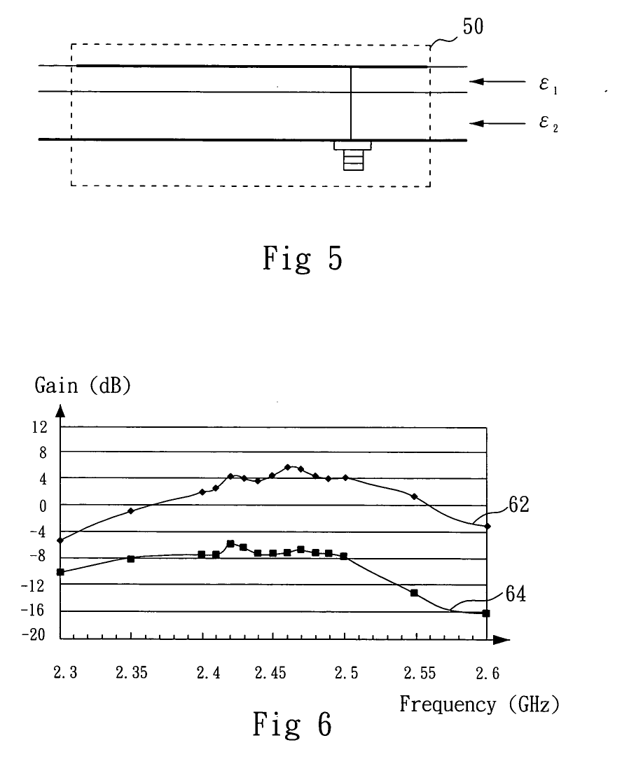

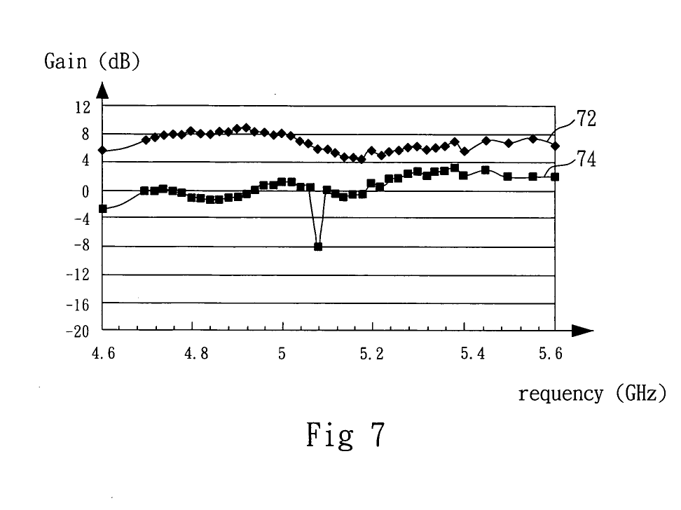

As shown in FIG. 4, the dual frequency antenna 50 in third embodiment comprises a square ring 52, a patch 54, and a feed line 56, wherein the square ring 52, the patch 54, and the feed line 56 do not connect electrically with each other. Especially, the dual frequency antenna in this embodiment uses a two-level substrate instead of the single-level substrate in the first and second embodiments. Additionally, the square ring 52, the patch 54, and the feed line 56 are placed on the surface of the two-level substrate. As shown in FIG. 5, the pre-determined working frequency of the square ring antenna is 2.45 GHz, so the preferred length of the outer side of the square ring 52 is 28 mm, the preferred length of the inner side is 20 mm, and the preferred width of the ring is 4 mm. Furthermore, the pre-determined working frequency of the patch antenna is 5.2 GHz, so the preferred length for the side of patch 54 is 16 mm. The length of the feed line 56 can be adjusted according to the demand of the user, but the preferred length is 7 mm and the preferred width is 1 mm; the spaces between the feed line 56 and the square ring 52 and the patch 54 are respectively 1 mm and 0.2 mm. Finally, the preferred dielectric coefficient ε₁ of the material for the first level of the two-level substrate is 4.4, and the preferred thickness is 1.6 mm; the square ring 52, patch 54, and feed line 56 are placed on the surface of the first level substrate. The preferred dielectric coefficient ε₂ of the material for the second level substrate is 1 (i.e. using air as a medium), and the preferred thickness is 3 mm. The second level substrate is preferably connected to the ground. In low frequency, the horizontal gain line 62 and the vertical gain line 64 of the dual frequency antenna are as shown in FIG. 6, and in high frequency, the horizontal gain line 72 and the vertical gain line 74 of the dual frequency antenna are as shown in FIG. 7. Obviously, under the horizontal polarization, both frequencies have high gain and are more efficient as in the first embodiment. Additionally, like the second embodiment, the user also can modify the dual frequency antenna 50 of the third embodiment in order for the dual frequency antenna to receive and transfer circular polarized signals.

Although the present invention has been explained in relation to its preferred embodiment, it is to be understood that many other possible modifications and variations can be made without departing from the scope of the invention as hereinafter claimed.

What is claimed is:

1. A dual frequency antenna comprises:
a square ring defining a central space;
a patch, which is placed at the central space of said square ring; and
a feed line for stimulating said square ring in order to form a square ring antenna, and stimulating said patch in order to form a patch antenna;
wherein said square ring, said patch, and said feed line are on a same surface, and said dual frequency antenna is used in a wireless LAN device.

2. The dual frequency antenna as claimed in claim 1, wherein said dual frequency antenna is placed on a circuit board which is made of FR4 material.

3. The dual frequency antenna as claimed in claim 1, wherein said wireless LAN device conforms with at least two of the following: IEEE 802.11a, IEEE 802.11b, and IEEE 802.11g.

4. The dual frequency antenna as claimed in claim 1, wherein said square ring has a male bevel edge, and said patch has a female bevel edge.

5. The dual frequency antenna as claimed in claim 1, wherein said dual frequency antenna is placed on top of a two-level substrate.

6. The dual frequency antenna as claimed in claim 5, wherein said two-level substrate is made of FR4 material and air.
